(19) United States
(12) Patent Application Publication
(10) Pub. No.: US 2018/0283514 A1
(43) Pub. Date: Oct. 4, 2018

(54) Two or Three Dimensional Oscillatory Motion to Rotary Motion Converter

(71) Applicant: Girish Jayashankara Aradhya Malligere, Frisco, TX (US)

(72) Inventor: Girish Jayashankara Aradhya Malligere, Frisco, TX (US)

(21) Appl. No.: 15/473,030

(22) Filed: Mar. 29, 2017

(51) Int. Cl. F16H 37/12; F16H 1/28

(52) U.S. Cl. CPC F16H 37/122; F16H 2001/2881; F16H 1/28

(57) ABSTRACT

A device which converts two dimensional or three dimensional oscillations into rotary shaft power by way of compressible linkage modules equipped with a one way clutch at one node of each linkage. A drive shaft attached to each linkage which in turn is attached to a main drive shaft rotates when the linkage module experiences oscillations causing the drive shaft attached to each linkage to rotate which causes the main drive shaft to rotate resulting in rotary shaft power.

### CROSS-REFERENCE TO RELATED APPLICATIONS

The current application claims the benefit and priority to U.S. Provisional Application No. 62/316,366 filed on Mar. 31, 2016 which is incorporated herein by reference as if fully set forth.

### STATEMENT REGARDING FEDERALLY SPONSORED RESEARCH OR DEVELOPMENT

No part of the invention disclosed herein was the subject of federally sponsored research or development.

### THE NAMES OF THE PARTIES TO A JOINT RESEARCH AGREEMENT

None

### REFERENCE TO A SEQUENCE LISTING

Not applicable.

### BACKGROUND OF THE INVENTION

### Field of the Invention

This invention relates to a means for converting two dimension or three dimensional oscillatory motions into rotary motion for the generation of electricity or rotary shaft power.

### Description of the Prior Art

Many methods and related apparati have been developed and used to translate energy from various sources and convert this energy into rotary shaft power which can be used for many applications such as the generation of electricity or powering a vehicle, among others. Sources of energy used by these methods are usually solar, wind, wave, geothermal or water. These sources of energy may be unreliable. Energy cannot be transformed into rotary shaft power at night when the sun is not shining or on a calm day when the wind is not of sufficient force, for example. The energy derived from the use of solar, wind, wave, geothermal or water is also inefficient and results in the inefficient conversion of these energy sources into usable power. Another source of potential energy is the oscillatory/motion energy present in most objects when in motion. Currently existing devices which translate oscillatory/motion energy to rotary shaft power capture the oscillatory/motion energy only in one dimension. This is inherently inefficient. Moreover, most single dimensional translators utilize gears, sprockets or belt to translate linear motion to shaft power. These prior art mechanisms are prone to system ply, slip or backlash. What is needed in the art is a method and apparatus to convert oscillatory/motion energy in two or three dimensions into usable rotary shaft power.

### BRIEF SUMMARY OF THE PRESENT INVENTION

The invention disclosed herein is a method and apparatus to convert oscillatory/motion energy in two or three dimensions into usable rotary shaft power. The invention disclosed herein consists of a plurality of linkage modules. A linkage module consists of four bar linkages with a one way clutch installed at one of the nodes where two linkages connect. There are two one way clutches on each linkage at this specific node. A drive shaft is installed at this node driven by the clutches. When an alternating load (axial tensile and compressive) is applied diagonally at the opposite node, the linkages expand and compress with each linkage rotating in a clockwise or anti-clockwise motion. The clutches engage and disengage the drive shaft alternatively driving the shaft in one specific direction completing the cycle during these phases. With a plurality of such modules arranged in different planes or dimension within the casing, combining each of their shaft rotations to a single main shaft, the two dimensional/three dimensional oscillatory motions to rotary motion converter is complete. When the casing is moved in different places, the module expands and contract producing rotary shaft power from oscillations/motion in two or three dimensions.

### BRIEF DESCRIPTION OF THE DRAWING/FIGURES

A better understanding of the invention disclosed herein may be had by examination of the following drawing/figures:

FIG. 1 is a top view of the linkage module;

FIG. 2 is a view of the two dimensional translator;

FIG. 3 is a view of the two dimensional translator;

FIG. 4 is a view of the linkage module replacement with a planetary gear translator module;

FIG. 5 is a view of the linkage module replacement with a planetary gear translator module;

FIG. 6 is a view of the linkage module replacement with a planetary gear translator module;

FIG. 6a is a view of the arrangement of the forward facing gear and aft facing gear in relation to the sun gear;

FIG. 6b is a view of the cluster gear;

FIG. 7 is a view of the three dimensional linkage translator assembly;

FIG. 8 is a view of the linkage assembly.

FIG. 9 is a view of the probe mount attachment to a linkage module assembly;

FIG. 10 is a view of the universal shaft coupling/joint;

FIG. 11 is a view of the planetary gear, sun gear and drive shaft assembly.

### DETAILED DESCRIPTION OF THE INVENTION

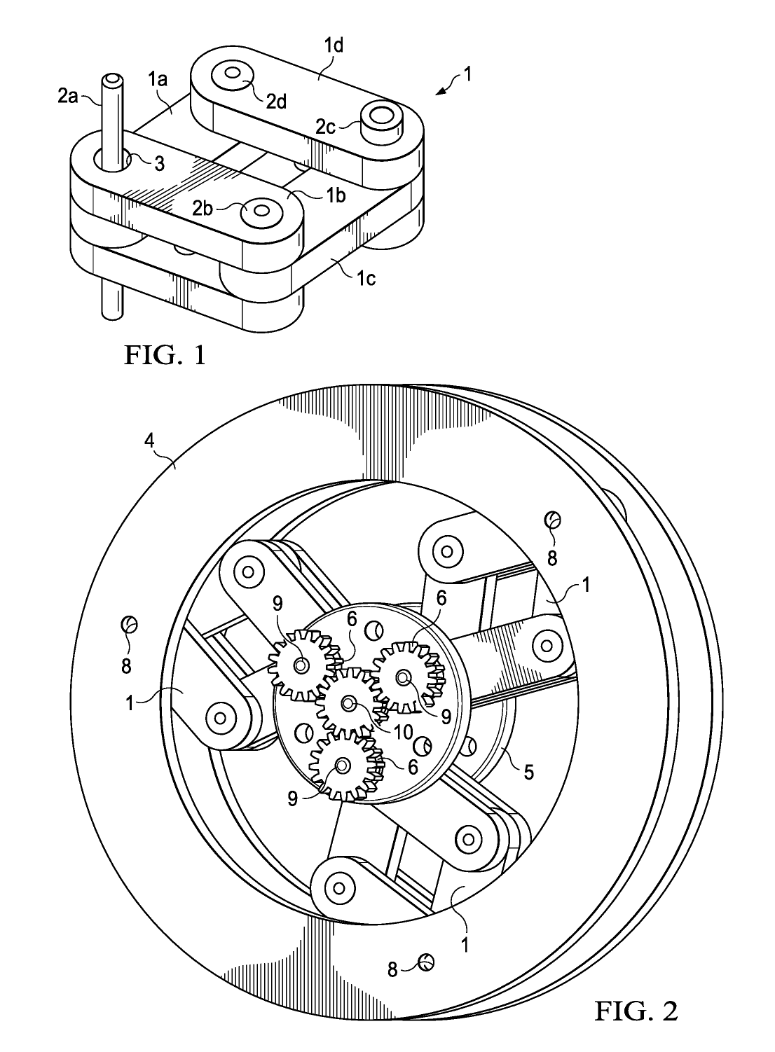

The basic unit of the two dimensional or three dimensional oscillatory motions to rotary motion converter is the linkage module. As shown in FIG. 1, the linkage module 1 consists of 4 linkages, 1a, 1b, 1c, and 1d connected at nodes 2a, 2b, 2c, and 2d to form a parallelogram. In one embodiment, a one way clutch 3 is installed at node 2a. As linkage 1d is compressed by oscillatory motion, it approaches linkage 1b causing linkage 1a to rotate in a counterclockwise fashion rotating the clutch 3 located in this embodiment in node 2a. When linkage 1d is expanded away from linkage 1b, linkage 1a rotates counterclockwise causing the one way clutch 3 in node 2a to rotate.

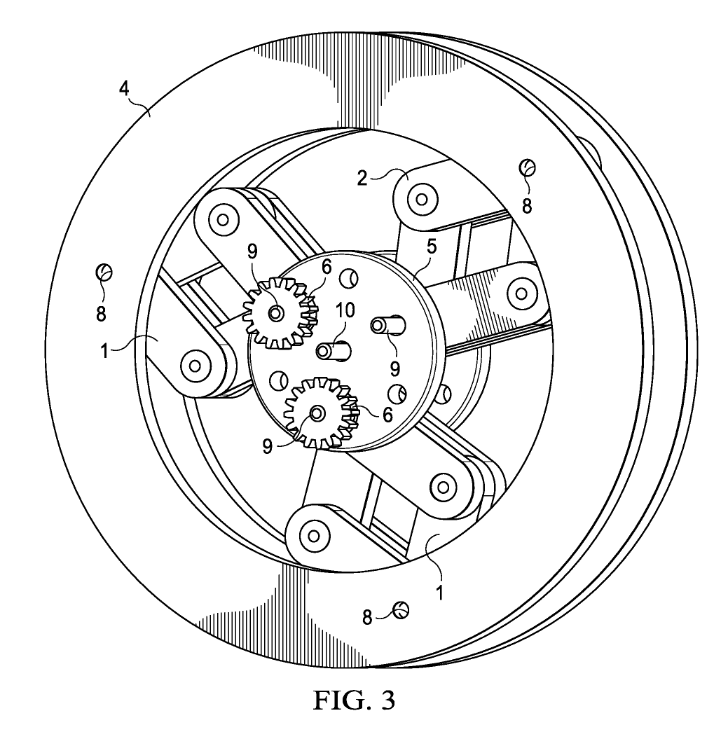

As shown in FIG. 2, a plurality of linkage modules 1 are attached to a casing ring 4 at the node opposite the node bearing the one way clutch. In the embodiment shown, 3 linkage modules 1 are incorporated into the casing ring 4 but any number of linkage modules 1 could be attached to the casing ring 4. In this embodiment the linkage modules are located 120 degrees apart from each other. The casing ring 4 is a housing in the shape of a ring with radially spaced attachment holes 8 for each linkage module 1. In this embodiment, the casing ring 4 consists of a two piece ring design that are installed parallel to each other and held together at each casing ring attachment hole 8. The linkage modules 1 are sandwiched between the two rings of the casing ring 4 and held in place by fasteners at the casing ring attachment holes 8 that allow free rotation of the linkage modules 1. The linkage modules 1 are attached to the casing ring 4 at the node opposite that node in which the one way clutch is located. The shaft hub 5 is a housing consisting of a plurality of bearing hubs to allow the installation of radially positioned drive shafts 9 and a main shaft 10 that is centrally located. In the embodiment shown, the shaft hub 5 is configured for three radially positioned drive shafts 9 and one centrally located main shaft 10. Attached to each of the radially positioned drive shafts 9 are planetary gears 6 which are connected by the drive shaft 9 to the one way clutch 3 on the linkage module 1. A main gear or sun gear 7 is attached to the main shaft 10. The sun gear 7 meshes with the planetary gears 6 and as the planetary gears 6 rotate, the sun gear 7 rotates driving the main shaft 10. The relationship of the drive shafts 9 and the main shaft 10 is shown in FIG. 3. The main shaft 10 is centrally located on the shaft hub 5. The drive shafts are arranged radially on the shaft hub 5 around the main shaft 10. In this view planetary gears 6 are shown attached to two of the drive shafts 9. As the linkage modules 1 compress and extend due to oscillatory motion, the plurality of drive shafts 9 rotate turning the corresponding planetary gear 6 attached to the end of the drive shaft 9 which in turn, drives the sun gear 7 which causes the main shaft 10 to rotate. In a two dimensional motion (X-Y plane), all the linkage modules compress and expand correspondingly, driving the shaft. This shaft power can be connected to drive a generator or any such device which uses rotary shaft power.

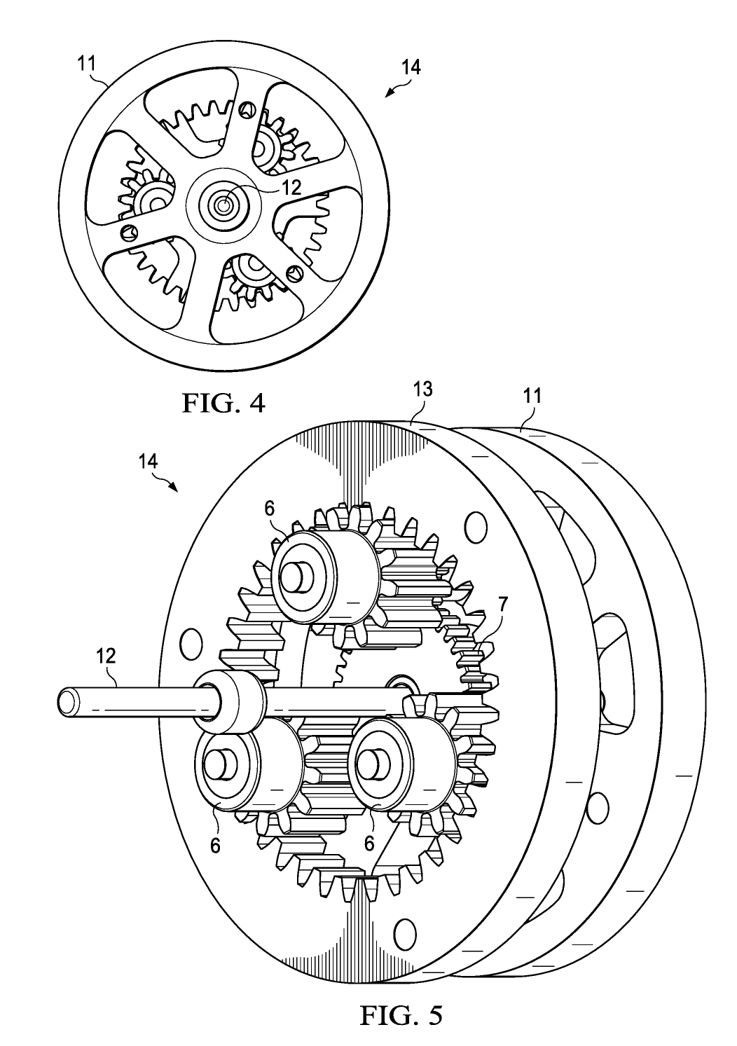

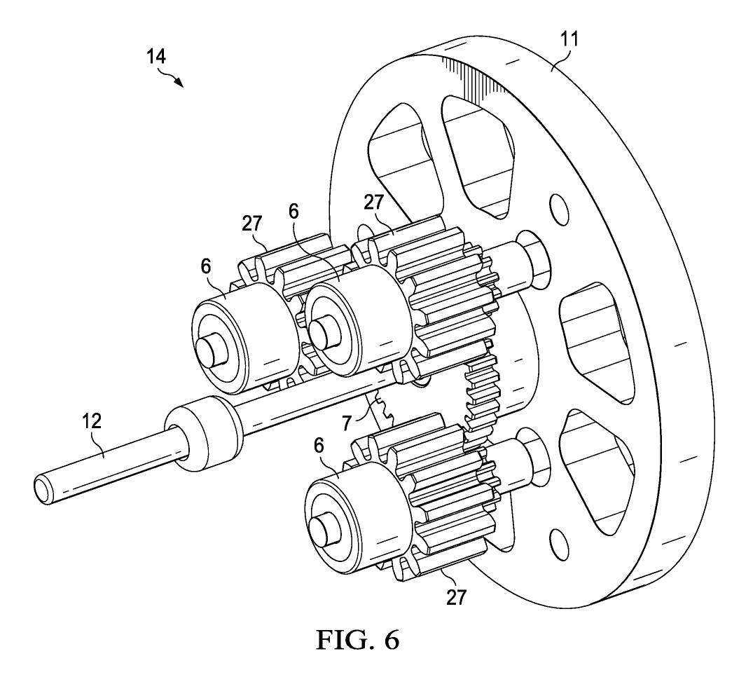

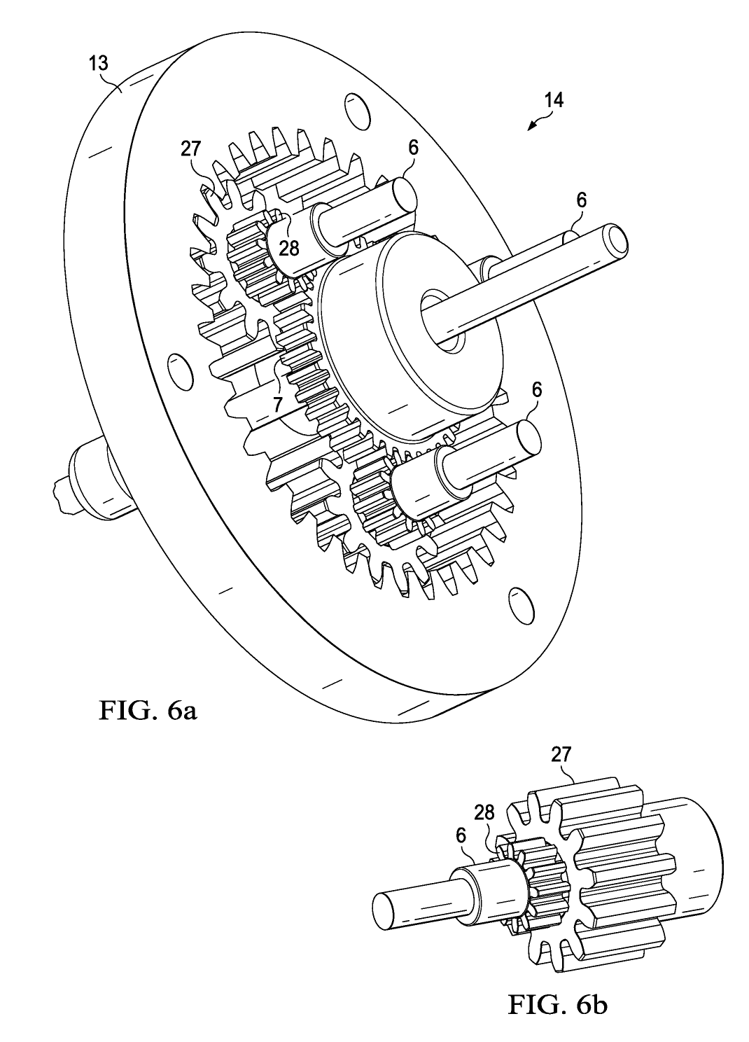

In another embodiment of the two dimensional oscillatory motion to rotary motion converter the linkage modules described above can be replaced by a planetary gear translator assembly as shown in FIGS. 4, 5, and 6, 6a and 6b. The planetary gear translator assembly 14 consists of an outer ring gear 13 installed within an outer case 11. In one embodiment, three planetary gears 6 are installed on a fixed plate to run along the outer ring gear 13. Each of the planet gears 6 is a dual coaxial gear with different gear pitches as shown in FIG. 5. The forward facing planet gear 27 engages the outer ring gear 13 while the aft facing planet gear 28 engages a sun gear 7. However, the gear ratios of the outer ring gear 13 and forward facing planet gears 27 is identical to the aft facing planet gear 6 and sun gear 7. This arrangement results in a one to one speed ratio. The outer case 11 has a central shaft with a hole to allow entry of the main drive shaft 12. The arrangement allows two shafts to be mounted coaxially. The outer case 11 also allows the installation of a one way clutch at its center to engage the main drive shaft 12. The main drive shaft 12 is then connected to the sun gear 7 with another one way clutch. The one way clutches are oriented to allow the main drive shaft 12 to rotate in one direction. When the outer case 11 is oscillated to and fro, the outer ring gear 13 drives the aft facing planet gear 6 in the same direction which in turn drives the sun gear 7 in the opposite direction. Thus, when the outer case 11 rotates clockwise, the clutch engages the main drive shaft 12 to rotate in the same direction and alternatively disengage in the opposite direction. The clutch within the sun gear 7 functions similarly. Therefore for every alternating rotation between the outer case 11 and the sun gear 7, the main drive shaft 12 completes a full rotation. A set of linkages connect between the casing ring 4 and the shaft on the outer case 11. Since the fixed plate is rigidly attached, the casing ring 4 is oscillated and the linkage modules compress and expand as described above. As a result, the shaft on the outer case 11 is rotated to and fro.

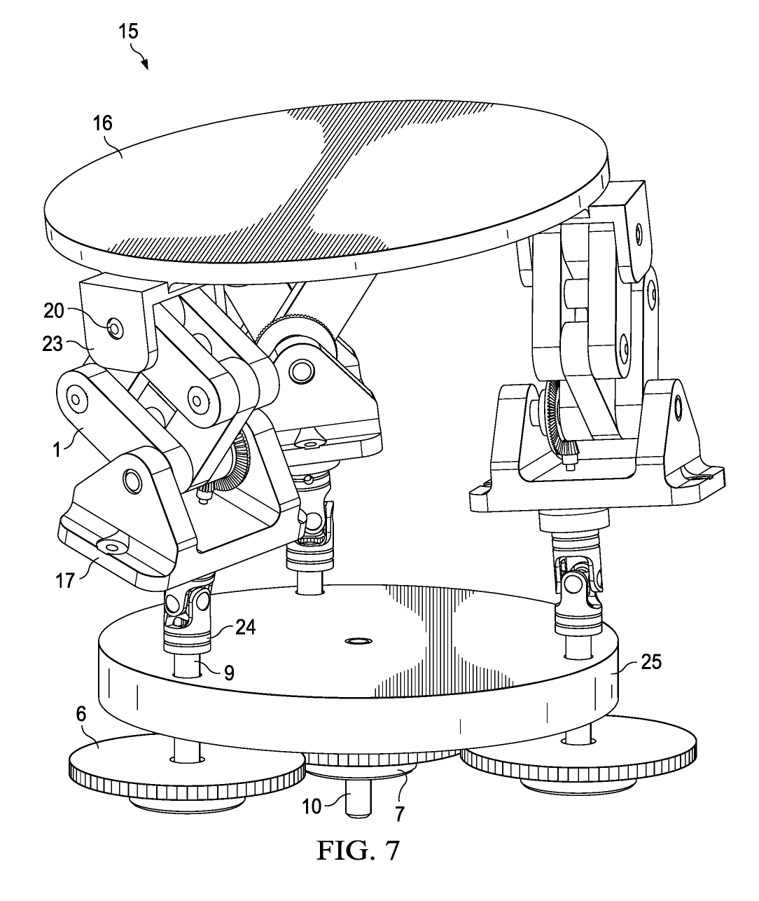

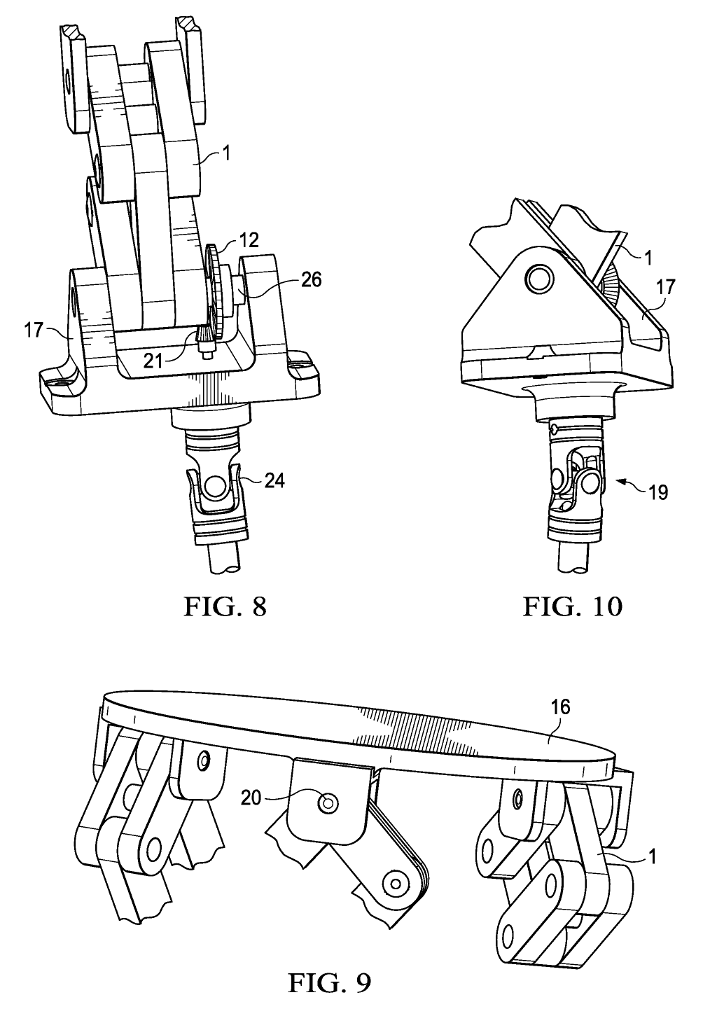

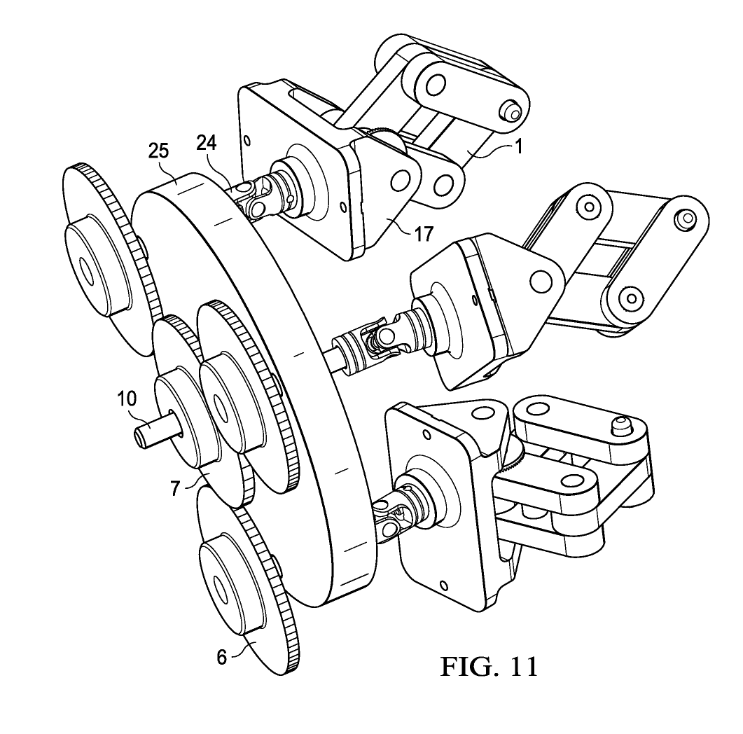

In another embodiment of the invention disclosed herein, the linkage modules described above can be mounted in an assembly so as to convert oscillatory vibrations from three dimensions into rotary power. As shown in FIGS. 7, 8, 9, 10 and 11. The three dimensional translator assembly 15 consists of a probe mount 16 attached through a probe mount bracket 23 at a pin joint 20 to a linkage module 1 at the node opposite the node of the linkage module 1 in which the one way clutch is located. The one way clutch of the linkage module 1 is attached to a linkage module gear 22 and linkage module hub 17. The linkage module gear 22 is meshed with a 90 degree bevel gear 21. The 90 degree bevel gear 21 is attached to a drive shaft 9 which extends through a base assembly 25 and which connects to a planetary gear 6 which is meshed with the sun gear 7. As the sun gear 7 rotates, the main shaft 10 rotates and produces rotary shaft power. The universal shaft coupling 24 maintains contact between the drive shaft 9 and the 90 degree bevel gear regardless of the orientation of the probe mount 16. This arrangement permits the conversion of oscillations experienced by the probe mount 16 into rotary power regardless of whether the oscillations are in one, two, three dimensions or a combination thereof.

The mechanical two dimensional and three dimensional oscillation energy translator disclosed herein is susceptible of being constructed and configured of different sizes and for a variety of applications. The invention disclosed herein is capable of capturing the energy of anything that vibrates and translating that energy into rotary power. This invention can be used as a regenerative device to replace a dampener in a vehicle suspension. When the suspension oscillates, shaft power is produced to run a generator or other device. A miniaturized version of the invention disclosed herein could be used for medical purposes such as powering cardiac pacemakers, delivering medicine or activating artificial limbs, among others. Such use could convert the vibrations from blood flow, heart beat or muscle contraction into rotary shaft power. Another use would be to convert water wave or wing flutter energy into rotary shaft power. The converted energy could power an electrical generator, pumps or propulsion systems such as propellers. All of these other embodiments are included within the specification as if specifically described and as covered by the appended claims.

I claim:

1. A two dimensional oscillatory motion to rotary motion converter comprising:
a casing ring;
a plurality of linkage modules configured with a one way clutch at the node of each linkage attached to each other and rotatably attached to said casing ring;
a main drive shaft with a main gear extending through the center of said casing ring;
a plurality of planetary drive shafts each with planetary gears and each attached to a said linkage at the node of said linkage opposite that node containing said one way clutch of said linkage;
said planetary gears meshed to said main gear;
whereby when said linkage module is compressed and extended by oscillation said planetary drive shafts rotate which in turn cause said main drive shaft to rotate producing rotary shaft power.

2. A two dimensional oscillatory motion to rotary motion converter comprising:
an outer ring gear installed within an outer case;
a plurality of planetary gears attached to a fixed plate;
a forward facing said planetary gear meshed with said outer ring gear;
an aft facing said planetary gear meshed with a sun gear;
a main drive shaft connected to said sun gear by a one way clutch and extending through said outer case;
whereby when said outer case is oscillated, said ring gear drives the plurality of said of said planet gears which rotates said sun gear causing the main shaft to rotate producing rotary shaft power;

3. A three dimensional oscillatory motion to rotary motion converter comprising:
a base assembly;
a plurality of linkage modules configured with a one way clutch at a node of each linkage attached to a linkage module gear;
said linkage module gear meshed to a 90 degree bevel gear;
a drive shaft to which said 90 degree bevel gear is attached which extends through said base assembly and which meshes with a planetary gear;
a main shaft;
a universal shaft coupling;
a sun gear attached to said main shaft and to which meshes with said planetary gear;
a probe mount attached to said linkage module at the node opposite the node with said one way clutch;
whereby oscillations experienced by said probe mount are converted into rotary shaft power regardless of the dimension in which the oscillation is experienced.
